(19) United States
(12) Patent Application Publication
(10) Pub. No.: US 2022/0036299 A1
(43) Pub. Date: Feb. 3, 2022

(54) INFORMATION PROCESSING APPARATUS, DELIVERY SCHEDULE OUTPUT METHOD, AND NON-TRANSITORY RECORDING MEDIUM

(71) Applicant: Yuuya OHTAKE, Kanagawa (JP)

(72) Inventor: Yuuya OHTAKE, Kanagawa (JP)

(73) Assignee: Ricoh Company, Ltd.

(21) Appl. No.: 17/389,346

(22) Filed: Jul. 30, 2021

(30) Foreign Application Priority Data
Aug. 3, 2020 (JP) 2020-131835

(51) Int. Cl. G06Q 10/08; G06Q 10/10; G06Q 10/06

(52) U.S. Cl. CPC G06Q 10/0833; G06Q 10/06311; G06Q 10/10

(57) ABSTRACT

An information processing apparatus includes circuitry configured to obtain delivery request information including information indicating a type of a delivery destination of a delivery object; determine, in response to the type of the delivery destination being a person, a delivery schedule based on schedule information indicating a schedule of the person, and determine, in response to the type of the delivery destination being a place, a delivery schedule based on delivery acceptable time range information indicating a time range during which a delivery is acceptable at the place; and output information indicating the delivery schedule.

### CROSS-REFERENCE TO RELATED APPLICATIONS

The present application is based on and claims priority under 35 U.S.C. § 119 to Japanese Patent Application No. 2020-131835, filed Aug. 3, 2020. The contents of Japanese Patent Application No. 2020-131835 are incorporated herein by reference in their entirety.

### BACKGROUND OF THE INVENTION

### 1. Field of the Invention

The present invention relates to an information processing apparatus, a delivery schedule output method, and a non-transitory recording medium.

### 2. Description of the Related Art

A system for managing or generating a delivery schedule has been disclosed. For example, there is disclosed a pickup and delivery schedule management system which is capable of accessing a website from a user terminal for confirming a pickup and delivery schedule and adding, changing, or deleting information included in the pickup and delivery schedule.

Japanese Unexamined Patent Application Publication No. 2005-138951 discloses the related art.

### SUMMARY OF THE INVENTION

The disclosed technique is an information processing apparatus including circuitry configured to obtain delivery request information including information indicating a type of a delivery destination of a delivery object; determine, in response to the type of the delivery destination being a person, a delivery schedule based on schedule information indicating a schedule of the person, and determine, in response to the type of the delivery destination being a place, a delivery schedule based on delivery acceptable time range information indicating a time range during which a delivery is acceptable at the place; and output information indicating the delivery schedule.

Other objects, features and advantages of the present invention will become more apparent from the following detailed description when read in conjunction with the accompanying drawings.

### BRIEF DESCRIPTION OF THE DRAWINGS

FIG. 1 is a diagram depicting an example of a system configuration of a delivery system;

FIG. 2 is a diagram depicting an example of a hardware configuration of an information processing apparatus;

FIG. 3 is a diagram depicting an example of functions of the information processing apparatus;

FIG. 4 is a diagram depicting an example of user information;

FIG. 5 is a diagram depicting an example of delivery place information;

FIG. 6 is a diagram depicting an example of delivery request information;

FIG. 7 is a diagram depicting an example of user schedule information;

FIG. 8 is a diagram depicting an example of reception hours information (which is an example of delivery acceptable time range information);

FIG. 9 is a diagram depicting an example of a process flow of the information processing apparatus;

FIG. 10 is a diagram depicting an example of a delivery request input screen page; and

FIG. 11 is a diagram depicting an example of a delivery schedule display screen page.

### DESCRIPTION OF THE EMBODIMENTS

In the related art, a delivery schedule can be provided based on a schedule of a person who is designated as a delivery destination. Therefore, according to the related art, even when a place where reception hours for delivery are set is designated as a delivery destination, a delivery schedule considering the reception hours cannot be provided. Thus, in the related art, it is difficult to provide a delivery schedule suitable for a type of a delivery destination.

The disclosed technique is intended to provide a delivery schedule suitable for a type of a destination.

Hereinafter, embodiments of a delivery system according to the present invention will be described with reference to the drawings.

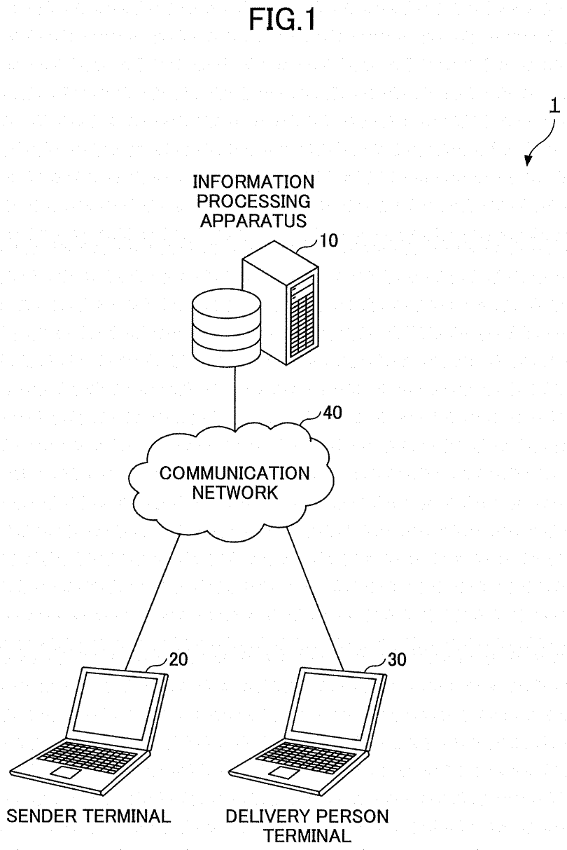

FIG. 1 is a diagram depicting an example of a system configuration of a delivery system.

The delivery system 1 includes an information processing apparatus 10, a sender terminal 20, and a delivery person terminal 30.

The information processing apparatus 10, the sender terminal 20, and the delivery person terminal 30 are communicatively connected to each other via a communication network 40.

The information processing apparatus 10 receives delivery request information representing a delivery request from the sender terminal 20, determines a delivery schedule, and transmits data representing the determined delivery schedule to the delivery person terminal 30.

The sender terminal 20 is a terminal operated by a sender. The sender is a user of the delivery system 1 and the user requests a delivery. The sender terminal 20 receives an operation of the user to input delivery request information and transmits the input delivery request information to the information processing apparatus 10. It should be noted that a person operating the sender terminal 20 need not be a person who actually owns a delivery object, and may be a delivery object recipient or another third party.

The delivery person terminal 30 is a terminal operated by a delivery person. The delivery person is a user of the delivery system 1 and is a person who implements a delivery. The delivery person terminal 30 receives data indicating a delivery schedule and displays the delivery schedule. It should be noted that a person operating the delivery person terminal 30 need not be a person who actually delivers a delivery object, and may be a person who communicates or instructs a delivery schedule to a delivery person.

The communication network 40 may be a wireless or wired network, and, for example, may be a local area network (LAN), a wide area network (WAN), a virtual private network (VPN), or the Internet.

Next, the hardware configuration of each of the apparatuses included in the delivery system 1 will be described.

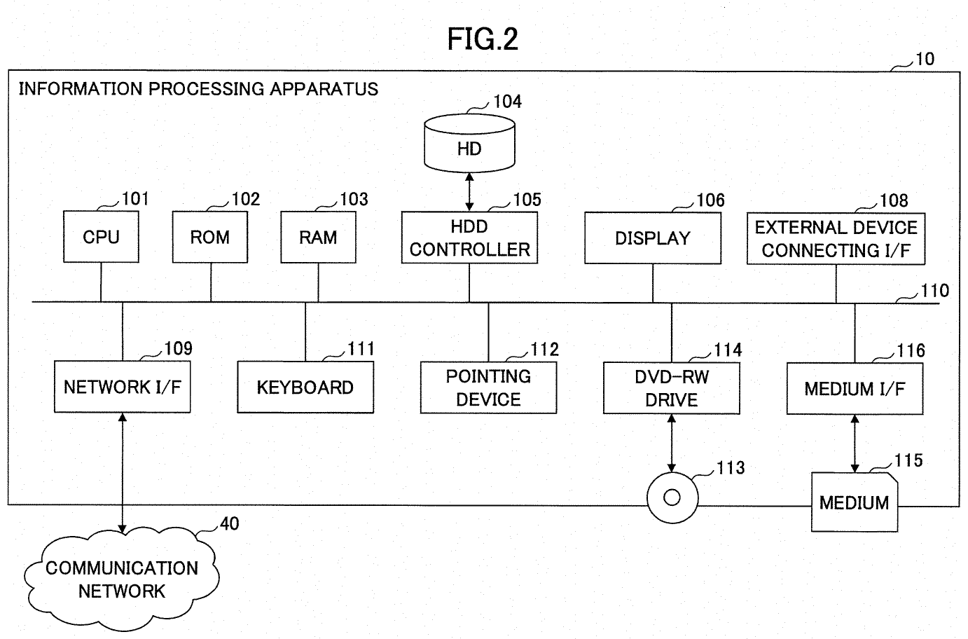

FIG. 2 is a diagram depicting an example of the hardware configuration of the information processing apparatus 10.

The information processing apparatus 10 is a computer and includes a CPU 101, a ROM 102, a RAM 103, a HD 104, a hard disk drive (HDD) controller 105, a display 106, an external device connecting interface (I/F) 108, a network I/F 109, a bus line 110, a keyboard 111, a pointing device 112, a digital versatile disk rewritable (DVD-RW) drive 114, and a medium I/F 116.

The CPU 101 controls operations of the entire information processing apparatus 10. The ROM 102 stores a program used to drive the CPU 101, such as an initial program loader (IPL). The RAM 103 is used as a work area of the CPU 101. The HD 104 stores a program and other data. The HDD controller 105 controls reading and writing of various data with respect to the HD 104 under the control of the CPU 101. The display 106 displays various information such as a cursor, a menu, a window, characters, and an image.

The external device connecting I/F 108 is an interface for connecting various external devices. The external devices include, for example, a universal serial bus (USB) memory, a printer, and so forth. The network I/F 109 is an interface for performing data communication with another apparatus using the communication network 40. The bus line 110 includes an address bus, a data bus, and so forth for electrically connecting elements such as the CPU 101 depicted in FIG. 2.

The keyboard 111 is one type of an input device having a plurality of keys for inputting characters, numbers, various indications, and so forth. The pointing device 112 is another type of an input device for selecting and executing various instructions, selecting a processing target, moving a cursor, and so forth. The DVD-RW drive 114 controls reading and writing of various data with respect to the DVD-RW 113 as an example of a removable recording medium. Not only a DVD-RW but also a DVD-R, or the like may be used instead. The medium I/F 116 controls reading and writing (storing) of data with respect to a medium 115, such as flash memory.

The sender terminal 20 and the delivery person terminal 30 have the same hardware configurations as the information processing apparatus 10 depicted in FIG. 2.

Next, functions of each of the apparatuses included in the delivery system 1 will be described.

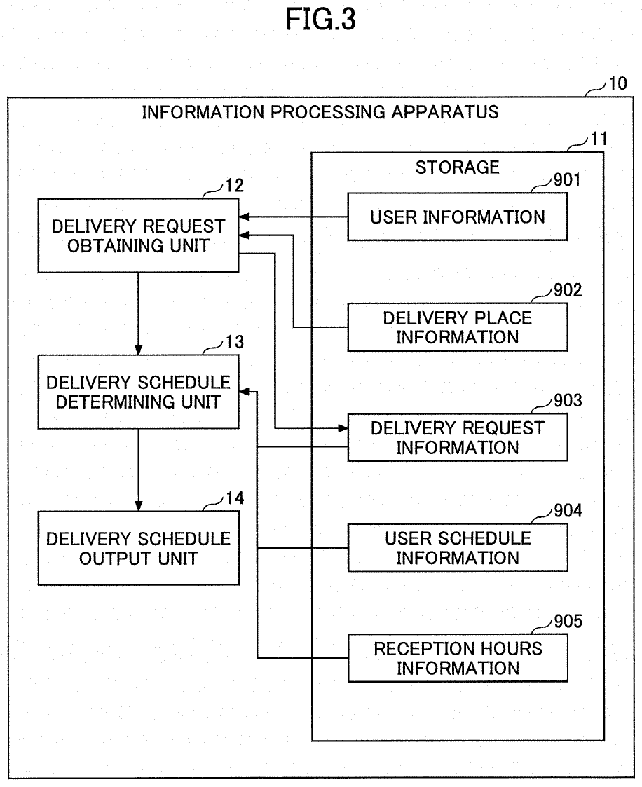

FIG. 3 is a diagram depicting an example of functions of the information processing apparatus.

The information processing apparatus 10 includes a storage 11, a delivery request obtaining unit 12, a delivery schedule determining unit 13, and a delivery schedule output unit 14.

The storage 11 stores various information. Specifically, the storage 11 stores user information 901, delivery place information 902, delivery request information 903, user schedule information 904, and reception hours information 905 (which is one example of delivery acceptable time range information).

The user information 901 is information of users who use the delivery system 1. The users included in the user information 901 are selected as delivery destinations. Examples of the user information 901 will be described later.

The delivery place information 902 is information indicating delivery places. The users included in the delivery place information 902 can be selected as delivery destinations. Examples of delivery place information 902 will be described later.

The delivery request information 903 is information indicating delivery requests. The delivery request information 903 includes information indicating whether delivery destinations are users included in the user information 901 or places included in the delivery place information 902. Examples of delivery request information 903 will be described later.

The user schedule information 904 is information indicating schedules of users. Specifically, the user schedule information 904 is information indicating schedules of conferences, holidays, and so forth of the users. Examples of the user schedule information 904 will be described later.

The reception hours information 905 is information indicating reception hours specified for each delivery destination place. Examples of reception hours information 905 will be described later.

The delivery request obtaining unit 12 obtains information representing delivery requests from the sender terminal 20. Specifically, the delivery request obtaining unit 12 requests the sender terminal 20 to display a delivery request input screen page and receives information input from the sender terminal 20 receiving an input operation performed by the sender. The delivery request obtaining unit 12 stores obtained delivery request information 903 in the storage 11. An example of the delivery request input screen page will be described later.

The delivery schedule determining unit 13 determines delivery schedules based on the delivery request information 903, the user schedule information 904, and the reception hours information 905. Specifically, the delivery schedule determining unit 13 determines delivery schedules based on the user schedule information 904 in cases of deliveries to users, whereas the delivery schedule determining unit 13 determines delivery schedules based on the reception hours information 905 in cases of deliveries to places. Determined delivery schedules include a scheduled delivery time range for each delivery of a date specified in the delivery request information 903.

The delivery schedule output unit 14 outputs data representing determined delivery schedules. Specifically, the delivery schedule output unit 14 transmits data including a scheduled delivery time range of the date specified for each delivery to the delivery person terminal 30.

Next, various information processed by the delivery system 1 will be described.

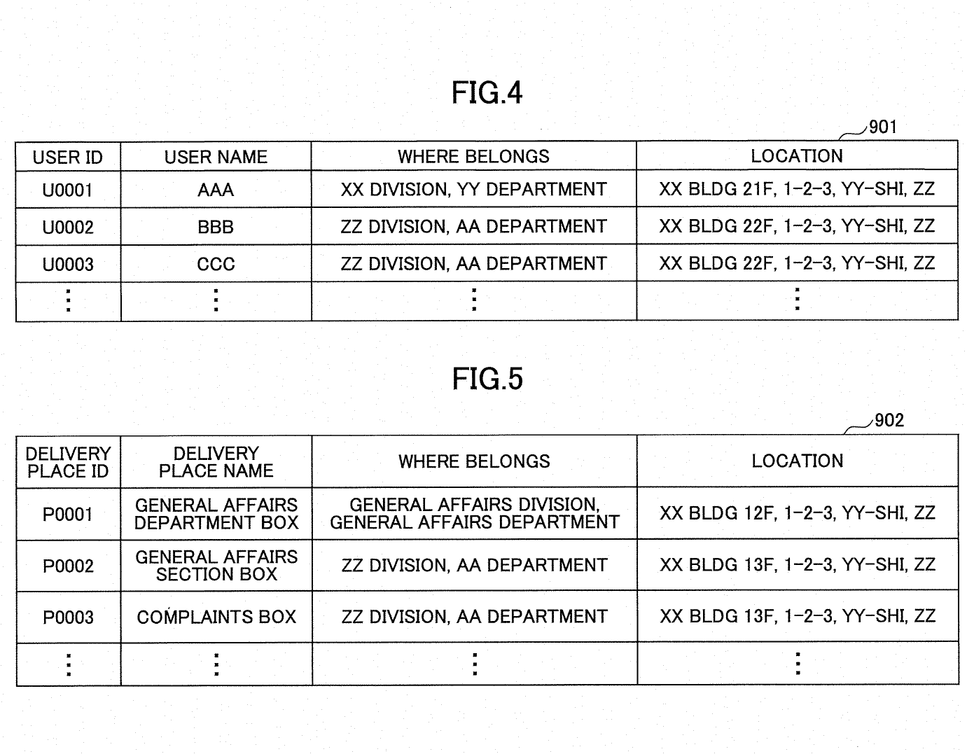

FIG. 4 is a diagram depicting an example of the user information.

The user information 901 includes, as items, user ID, user name, where belongs, and location.

A value of the item “user ID” is an identifier to identify a user.

A value of the item “user name” is a name of a user.

A value of the item “where belongs” is an organization or the like to which a user belongs.

A value of the item “location” indicates a residence where a user normally resides. A value of the item “location” may be an address or, as long as a delivery person understands, may be a district code, area name, building name, or the like.

FIG. 5 is a diagram depicting an example of the delivery place information.

The delivery place information 902 includes, as items, delivery place ID, delivery place name, where belongs, and location.

A value of the item “delivery place ID” is an identifier to identify a delivery destination location.

A value of the item “delivery place name” is a name of a delivery destination location.

A value of the item “where belongs” indicates an organization or the like managing a delivery destination location.

A value of the item “location” indicates a location of a delivery destination location. A value of the item “location” may be an address, and, as long as a delivery person understands, may be a district code, area name, building name, or the like.

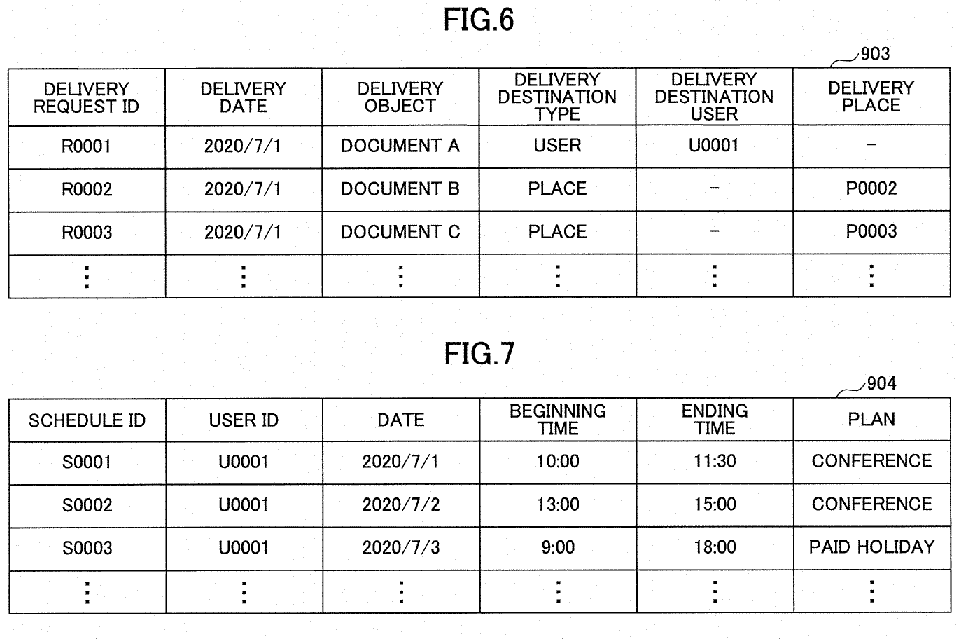

FIG. 6 is a diagram depicting an example of the delivery request information.

The delivery request information 903 includes as items, delivery request ID, delivery date, delivery object, delivery destination type (a type of a delivery destination), delivery destination user, and delivery destination place.

A value of the item “delivery request ID” is an identifier to identify a delivery request.

A value of the item “delivery date” is a designated date of a delivery.

A value of the item “delivery object” is a character string indicating what is to be delivered.

A value of the item “delivery destination type” indicates whether a delivery destination is a user (person) or a place.

A value is set at the item “delivery destination user” when a value of the item “delivery destination type” indicates a user. A value of the item “delivery destination user” is an identifier (user ID) to identify a user who is a delivery destination.

A value is set at the item “delivery place” when a value of the item “delivery destination type” indicates a place. A value of the item “delivery place” is an identifier to identify a destination location. Thus, a value of the item “delivery destination type” indicates a type of a delivery destination. A value of the item “delivery destination user” indicates a delivery destination when a delivery destination type is a person. A value of the item “delivery place” indicates a delivery destination when a delivery destination type is a place.

For example, in the example of FIG. 6, a delivery request identified by a delivery request ID “R0001” is a request to deliver a document A to a user identified by a user ID “U0001” on Jul. 1, 2020. A delivery request “R0002” is a request to deliver a document B to a delivery place “P0002” on Jul. 1, 2020.

FIG. 7 is a diagram depicting an example of the user schedule information.

The user schedule information 904 includes, as items, schedule ID, user ID, date, beginning time, ending time, and plan.

A value of the item “schedule ID” is an identifier to identify a schedule for each plan.

A value of the item “user ID” is an identifier to identify a user.

A value of the item “date” is a date on which a user is scheduled to carry out a plan.

A value of the item “beginning time” is a time at which a user is scheduled to start carrying out a plan.

A value of the item “ending time” is a time at which a user is scheduled to end carrying out a plan.

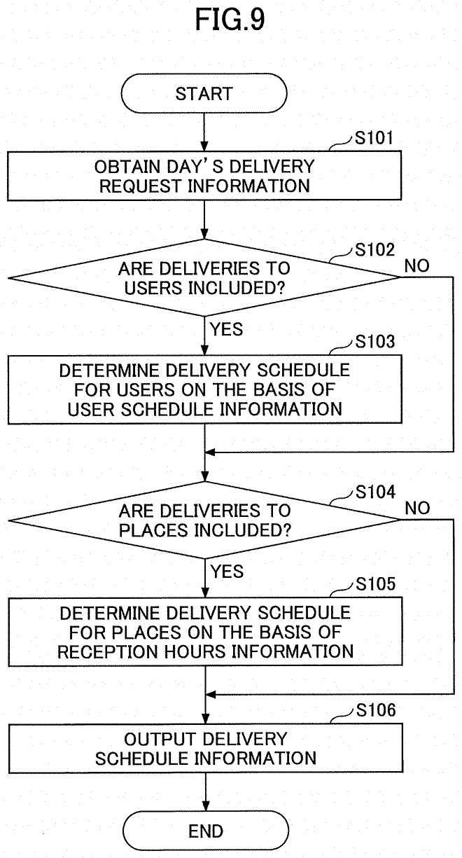

A value of the item “plan” is a character string indicating a plan. A value of the item “plan” is not used for processes that will be described later with reference to FIG. 9.

The user schedule information 904 is information representing a time range during which a user is absent at a location where the user is normally present. For example, in the example of FIG. 7, a user “U0001” is scheduled to be absent at a location where the user is normally present, from 10:00 to 11:30 of Jul. 1, 2020.

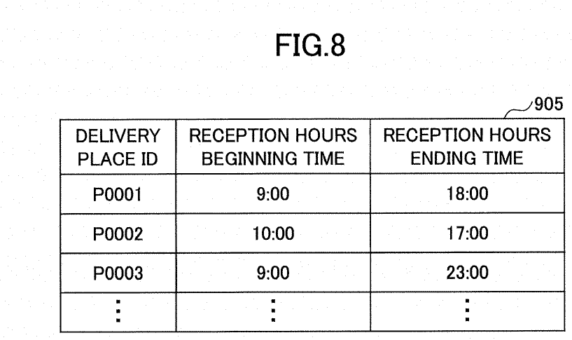

FIG. 8 is a diagram depicting an example of the reception hours information.

The reception hours information 905 includes, as items, delivery place ID, reception hours beginning time, and reception hours ending time.

A value of the item “delivery place ID” is an identifier to identify a delivery destination location.

A value of the item “reception hours beginning time” indicates a time from which a delivery acceptable time range of a delivery destination location starts.

A value of the item “reception hours ending time” is a time at which a delivery acceptable time range of a delivery destination location ends.

For example, in the example of FIG. 8, deliveries are acceptable at a delivery place “P0001” from 9:00 to 18:00.

Next, operations of the delivery system 1 will be described.

FIG. 9 is a diagram depicting an example of a process flow of the information processing apparatus.

The information processing apparatus 10 performs processes described below once a day at a time before deliveries are started by the delivery person. In step S101, the delivery request obtaining unit 12 of the information processing apparatus 10 obtains a set of a day's delivery request information. Specifically, the delivery request obtaining unit 12 extracts a set of the day's delivery request information from the delivery request information 903 stored in the storage 11.

Next, in step S102, the delivery schedule determining unit 13 determines whether deliveries to users are included in the obtained set of delivery request information. In step S103, when it is determined that deliveries to users are included (Yes in step S102), the delivery schedule determining unit 13 determines a delivery schedule to the users based on the user schedule information 904.

Specifically, the delivery schedule determining unit 13 determines, with the use of the user schedule information 904, a delivery schedule for each delivery in a manner of avoiding setting a time span where a user who is a delivery destination is not present on the corresponding day at the location where the user is normally present.

When it is determined that deliveries to users are not included (No in step S102), the delivery schedule determining unit 13 skips step S103.

Next, in step S104, the delivery schedule determining unit 13 determines whether deliveries to places are included in the obtained delivery request information. In step S105, when it is determined that deliveries to places are included (Yes in step S104), the delivery schedule determining unit 13 determines a delivery schedule to the places on the basis of the reception hours information 905.

Specifically, the delivery schedule determining unit 13 determines a delivery schedule for each delivery on the basis of the reception hours information 905 in a manner of being able to implement a delivery during a time span where deliveries are acceptable at a corresponding delivery place.

When it is determined that deliveries to places are not included (No in step S104), the delivery schedule determining unit 13 skips step S105.

Subsequently, in step S106, in the case where at least one of the delivery schedule for the deliveries to the users and the delivery schedule for the deliveries to the places has been thus determined, the delivery schedule output unit 14 outputs information representing the determined delivery schedule(s). Specifically, the delivery schedule output unit 14 transmits information representing the delivery schedule(s) in response to a request from the delivery person terminal 30. The delivery schedule output unit 14 may periodically transmit information indicating a delivery schedule(s) to the delivery person terminal 30, for example, once a day.

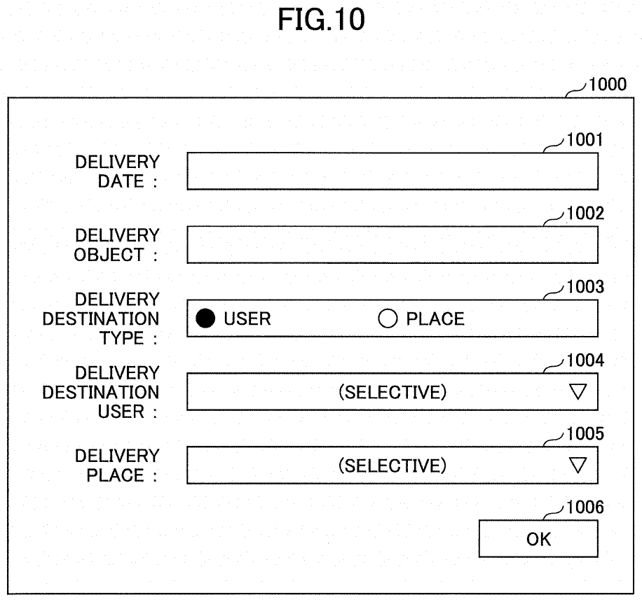

FIG. 10 is a diagram depicting an example of a delivery request input screen page.

The delivery request input screen page 1000 is a screen page displayed on the sender terminal 20 for receiving a user's delivery request input operation. Specifically, the delivery request input screen page 1000 includes a delivery date input field 1001, a delivery object input field 1002, a delivery destination type selection field 1003, a delivery destination user selection field 1004, a delivery place selection field 1005, and a fixing button 1006.

The delivery date input field 1001 is a text box to input a delivery date. The delivery object input field 1002 is a text box to input a name of a delivery object. The delivery destination type selection field 1003 is a radio button for selecting one of “user” and “place” as a delivery destination type.

The delivery destination user selection field 1004 is for selecting a delivery destination user and is of pull-down menu type. In the delivery destination user selection field 1004, the values of the item “user name” included in the user information 901 are displayed in a form of a pull-down menu, from which a delivery destination user is selected.

The delivery place selection field 1005 is for selecting a delivery destination location (a delivery place) and is of pull-down menu type. In the delivery place selection field 1005, the values of the item “delivery place name” included in the delivery place information 902 are displayed in the form of a pull-down menu, from which a delivery place is selected.

The fixing button 1006 is a button for fixing the contents having been thus input from the delivery request input screen page. When the fixing button 1006 is pressed, the sender terminal 20 transmits delivery request information representing the input contents to the information processing apparatus 10.

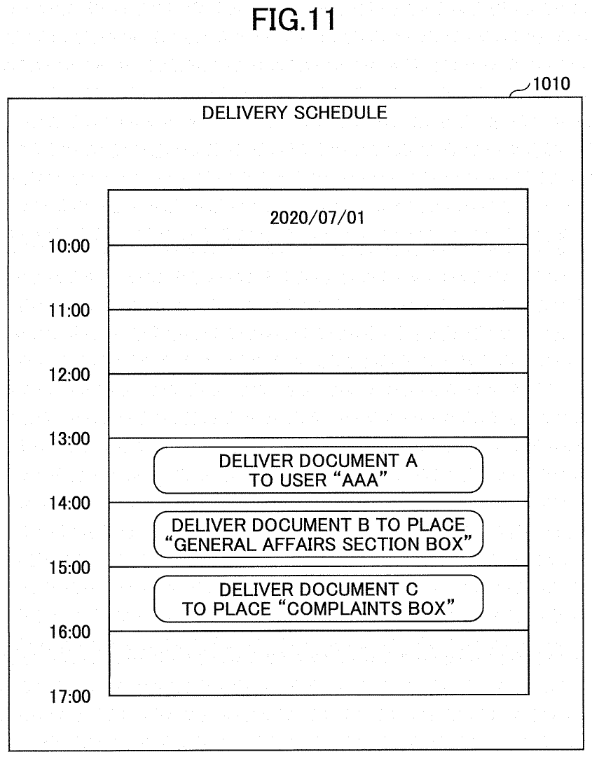

FIG. 11 is a diagram depicting an example of a delivery schedule display screen page.

The delivery schedule display screen page 1010 is displayed on the delivery person terminal 30 that receives delivery schedule information from the information processing apparatus 10.

The delivery schedule display screen page 1010 includes a scheduled delivery time range for each delivery at a date.

For example, in the example depicted in FIG. 11, a delivery of a document A to a user “AAA” is scheduled from 13:00 to 14:00. This is a result of considering not to implement a delivery between 10:00 and 11:30 based on the set of schedule information having the schedule ID “S0001” depicted in FIG. 7.

A delivery of a document B to a “general affairs section box” is scheduled to from 14:00 to 15:00. This is a result of considering to implement a delivery between 10:00 and 17:00, i.e., during the reception hours of the delivery place having the delivery place ID “P0002” depicted in FIG. 8.

The delivery schedule display screen page 1010 may include a reception hours beginning time and a reception hours ending time of a delivery place for a delivery to the delivery place. As a result, a delivery can be implemented within a time range where deliveries are acceptable even if there occurs a delay in the delivery schedule.

Thus, in the delivery system 1 according to the present embodiment, a delivery schedule can be provided in accordance with a type of a delivery destination.

As described above, in step S106 of FIG. 9, delivery schedule information is transmitted from the information processing apparatus 10, received by the delivery person terminal 30, and is displayed on the delivery person terminal 30. In this regard, delivery schedule information received by the delivery person terminal 30 may be used not only as being displayed on the delivery person terminal 30 to a delivery person as described above but also as will be described below.

In response to delivery schedule information, the delivery person terminal 30 automatically selects one or more delivery personnel, from among previously registered a plurality of delivery personnel, suitable to deliveries listed in the delivery schedule information. The selection of the delivery person terminal 30 may be implemented on the basis of a database or the like storing current locations of the registered delivery personnel; delivery tasks to which the registered delivery personnel have been already assigned; and respective delivery task schedules of the registered delivery personnel. The delivery person terminal 30 then automatically sends information to the thus selected one or more delivery personnel to request executing delivery jobs according to the delivery schedule information.

In this regard, instead of using registered delivery personnel, unmanned delivery machines such as drones may be used. In this case, such unmanned delivery machines are automatically controlled by the delivery person terminal 30 so that corresponding delivery objects will be delivered to delivery destinations automatically.

In addition, a plurality of delivery person terminals 30 may be prepared. In this case, the plurality of delivery person terminals belong to respective schedule management systems of corresponding users which may be delivery companies or who receive corresponding delivery objects.

In the delivery system 1 according to the present embodiment, because a delivery schedule can be provided based not only on schedules of users to whom deliveries are implemented but also on reception hours of destination places, it is possible to provide delivery schedules in response to various delivery requests.

In the embodiment described above, the example of determining a delivery time in response to a delivery request having a given delivery date has been described. However, a delivery request need not have a delivery date, and may have only a delivery deadline. In this case, the delivery schedule determining unit 13 determines a delivery schedule including a determined delivery date determined on the basis of the deadline.

The group of the apparatuses described in each embodiment represents only one example from among a plurality of computing environments for carrying out the embodiments disclosed herein.

In some embodiments, the information processing apparatus 10 may be configured as an information processing system, such as a cloud service or a Web service, including a plurality of computing devices, such as a server cluster. The plurality of computing devices are configured to communicate with each other via any type of a communication link that may be a network, a shared memory, or the like, and may perform the processes disclosed herein.

The information processing apparatus 10, the sender terminal 20, and the delivery person terminal 30 may be configured to share the disclosed processing steps in various combinations. The information processing apparatus 10, the sender terminal 20, and the delivery person terminal 30 as the respective elements may be integrated into a single server apparatus; or each of the information processing apparatus 10, the sender terminal 20, and the delivery person terminal 30 may be divided into plural apparatuses.

Each of the functions of the embodiments described above may be implemented by one or more processing circuits. A “processing circuit” used herein may be a processor programmed to perform each function by software, such as a processor implemented as an electronic circuit, or may be a device designed to perform each function as described above such as an application specific integrated circuit (ASIC), a digital signal processor (DSP), a field programmable gate array (FPGA), or a conventional circuit module.

Although the information processing apparatuses, delivery schedule output methods, and non-transitory recording media have been described with reference to the embodiments, the present invention is not limited to the embodiments and various variations and modifications can be made within the scope of the present invention.

Thus, although the present invention has been described on the basis of the embodiments, the present invention is not limited to the features described in the embodiments. In these respects, the embodiments may be changed without departing from the subject matter of the present invention, and may be suitably changed in accordance with their applications.

What is claimed is:

1. An information processing apparatus, comprising
circuitry configured to:
obtain delivery request information including information indicating a type of a delivery destination of a delivery object;
determine, in response to the type of the delivery destination being a person, a delivery schedule based on schedule information indicating a schedule of the person, and determine, in response to the type of the delivery destination being a place, a delivery schedule based on delivery acceptable time range information indicating a time range during which a delivery is acceptable at the place; and
output information indicating the delivery schedule.

2. The information processing apparatus according to claim 1, wherein
the delivery acceptable time range information includes a delivery acceptable time range beginning time indicating a beginning of allowing acceptance of a delivery and a delivery acceptable time range ending time indicating an ending of allowing acceptance of a delivery, and
the circuitry is further configured to determine, in response to the type of the delivery destination being the place, the delivery schedule in a manner of implementing a delivery at a time between the delivery acceptable time range beginning time and the delivery acceptable time range ending time.

3. The information processing apparatus according to claim 1, wherein
the delivery request information includes a designated date of a delivery for each delivery object, and
the circuitry is further configured to determine the delivery schedule including a scheduled time range of a delivery at a designated date for each delivery object.

4. The information processing apparatus according to claim 1, wherein
the circuitry is further configured to periodically output information indicating a delivery schedule.

5. A method executed by a processor, comprising:
obtaining delivery request information including information indicating a type of a delivery destination of a delivery object;
determining, in response to the type of the delivery destination being a person, a delivery schedule based on schedule information indicating a schedule of the person, and determining, in response to the type of the delivery destination being a place, a delivery schedule based on delivery acceptable time range information indicating a time range during which a delivery is acceptable at the place; and
outputting information indicating the delivery schedule.

6. The method according to claim 5, wherein
the delivery acceptable time range information includes a delivery acceptable time range beginning time indicating a beginning of allowing acceptance of a delivery and a delivery acceptable time range ending time indicating an ending of allowing acceptance of a delivery, and
the method comprises determining, in response to the type of the delivery destination being the place, the delivery schedule in a manner of implementing a delivery at a time between the delivery acceptable time range beginning time and the delivery acceptable time range ending time.

7. The method according to claim 5, wherein
the delivery request information includes a designated date of a delivery for each delivery object, and
the method comprises determining the delivery schedule including a scheduled time range of a delivery at a designated date for each delivery object.

8. The method according to claim 5, comprising
periodically outputting information indicating a delivery schedule.

9. A non-transitory recording medium storing a program, which when executed by a processor, causes the processor to:
obtain delivery request information including information indicating a type of a delivery destination of a delivery object;
determine, in response to the type of the delivery destination being a person, a delivery schedule based on schedule information indicating a schedule of the person, and determine, in response to the type of the delivery destination being a place, a delivery schedule based on delivery acceptable time range information indicating a time range during which a delivery is acceptable at the place; and
output information indicating the delivery schedule.
